(19) United States
(12) Patent Application Publication
(10) Pub. No.: US 2004/0165614 A1
(43) Pub. Date: Aug. 26, 2004

(54) System for extending distance of x Digital Subscriber Line using reserved telephone line

(76) Inventor: Kun-Hak Lee, Seoul (KR)

Correspondence Address: Robert E. Bushnell, Suite 300, 1522 K Street, N.W., Washington, DC, 20005, US

(21) Appl. No.: 10/779,785

(22) Filed: Feb. 18, 2004

(30) Foreign Application Priority Data
Feb. 24, 2003 (KR) 2003-11479

(51) Int. Cl. H04L 12/66

(52) U.S. Cl. 370/463

(57) ABSTRACT

A system for extending an x Digital Subscriber Line (xDSL) distance using a reserved telephone line in accordance with the present invention, includes: a Customer-Provided Equipment (CPE) for supplying an x Digital Subscriber Line (xDSL) transmission service to a subscriber terminal; a Digital Subscriber Line Access Multiplexer (DSLAM) setting an initial link with the Customer-Provided Equipment (CPE) for the x Digital Subscriber Line (xDSL) transmission service, and transceiving data with the Customer-Provided Equipment (CPE) through the set link; and a distance extension module being installed with at least more than one module between the Digital Subscriber Line Access Multiplexer (DSLAM) and the Customer-Provided Equipment (CPE), in order to receive x Digital Subscriber Line (xDSL) transmission data from the Digital Subscriber Line Access Multiplexer (DSLAM) in connection with an optional reserved telephone line selected from telephone line bundles incoming from the Digital Subscriber Line Access Multiplexer (DSLAM), and after separating the received transmission data, to transmit the separated transmission data to a module of a back end or the Customer-Provided Equipment (CPE) or to transmit transmission data received from the module of the back end or the Customer-Provided Equipment (CPE).

### CLAIM OF PRIORITY

This application makes reference to, incorporates the same herein, and claims all benefits accruing under 35 U.S.C. § 119 from an application for SYSTEM FOR EXTENDING x DIGITAL SUBSCRIBER LINE USING RESERVED TELEPHONE LINE earlier filed in the Korean Intellectual Property Office on Feb. 24, 2003 and there duly assigned Serial No. 2003-11479.

### BACKGROUND OF INVENTION

1. Field of the Invention

The present invention generally relates to a system for extending a distance of x Digital Subscriber Line distance (xDSL) using a reserved telephone line, and more specifically, to a system for extending a distance of an xDSL using a reserved telephone line for overcoming limits in the distance of xDSL by using reserved telephone lines supplied as reserved lines among telephone lines connected in a bundle up to homes from a Digital Subscriber Line Access Multiplexer (DSLAM).

2. Description of Related Art

Concerning a communication line format to a Customer-Provided Equipment (CPE) from a general telephone office, as for a communication method like xDSL, the xDSL is transmitted to an adjacent home DSLAM from a telephone office by an optical cable, and is connected to a CPE from the DSLAM with the use of telephone lines (Twisted Pair). xDSLs include for example ADSL (Asymmetrical DSL), UADSL (Universal Asymmetrical DSL), HDSL (High bit rate DSL), SDSL (Symmetrical DSL), MSDSL (Multirate Symmetrical DSL), RADSL (Rate Adaptive DSL), IDSL (ISDN (Integrated services digital network) like DSL), and VDSL (Very high DSL), etc.

At this time, most telephone lines are in a bundle, bound by a plurality of telephone lines, and is connected to a home by being divided in a home entry port through a distributor or a terminal box (TAB).

Generally, the telephone lines distributed from a bundle are supplied with approximately 4 to 5 reserved telephone lines per home. However, among the telephone lines, one telephone line having the best features is used. That is, there are 3 to 4 reserved telephone lines supplied as reserved lines every home, even though they are not currently used at home.

Thus, the xDSL is divided into the DSLAM and the CPE, a home terminal equipment, and is connected in 1:1 way, what is called peer-to-peer system, with the use of one telephone line.

Meanwhile, according to Shannon-Heartley Capacity theory, the telephone lines (Twisted. Pair) are characteristic of reducing a maximum transfer rate as it is a longer way. So, if distance between the DSLAM and the CPE is far away from a regular range, efficiency and a signaling speed of the xDSL get lower and lower. As a result, an Asymmetric Digital Subscriber Line (ADSL) system or a Very high-date rate Digital Subscriber Line (VDSL) system cannot overcome distance limits in spite of high technologies.

As stated above, an earlier xDSL communication system performs communication by using telephone lines, but has distance limits in terms of characteristics of the telephone lines. In addition, since the telephone lines are in a bundle, the telephone lines are transmitted to each home from the ONU (optical network unit) (DSLAM) by various xDSL communication systems. Thus, it gets a much shorter distance due to overlapping or cross talk of usable frequency regions of the telephone lines having different communication systems.

### SUMMARY OF THE INVENTION

It is therefore an object of the present invention to provide a system for extending a distance of xDSL using a reserved telephone line to enable a service in a shadow region where it is hard to give the service owing to distance limits, by using the reserved telephone line supplied to home but not used, in order to overcome the distance limits, disadvantages of the xDSL using the prior telephone lines.

It is another object to provide a system for extending a distance of xDSL using a reserved telephone line to enable to reduce development periods and costs with an easy implementation.

It is yet another object to provide a system for extending a distance of xDSL using a reserved telephone line to enable more efficient xDSL communication.

To accomplish the above and other objects, according to one aspect of the present invention, the present invention includes: a CPE for supplying an xDSL transmission service to a subscriber terminal; a DSLAM setting an initial link with the CPE for the xDSL transmission service, and transceiving data with the CPE through the set link; and a module for distance extension being installed with at least more than one module between the DSLAM and the CPE, in order to receive xDSL transmission data from the DSLAM in connection with an optional reserved telephone line selected from telephone line bundles incoming from the DSLAM, and after separating the transmission data received, to transmit the transmission data separated to a module of a back end or the CPE or to transmit transmission data received from the module of the back end or the CPE.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a communication line format diagram up to a CPE from a general telephone office;

FIG. 2 is a diagram illustrating a concept of extending an available distance of xDSL through modules for distance extension of xDSL using a reserved telephone line in accordance with one embodiment of the present invention;

FIG. 3 is a block diagram showing a configuration of a distance extension module installed in one terminal box of FIG. 2;

FIG. 4 is a diagram illustrating a concept of extending an available distance of xDSL through modules for distance extension of xDSL using a reserved telephone line in accordance with another embodiment of the present invention.

### DETAILED DESCRIPTION OF EXEMPLARY EMBODIMENTS

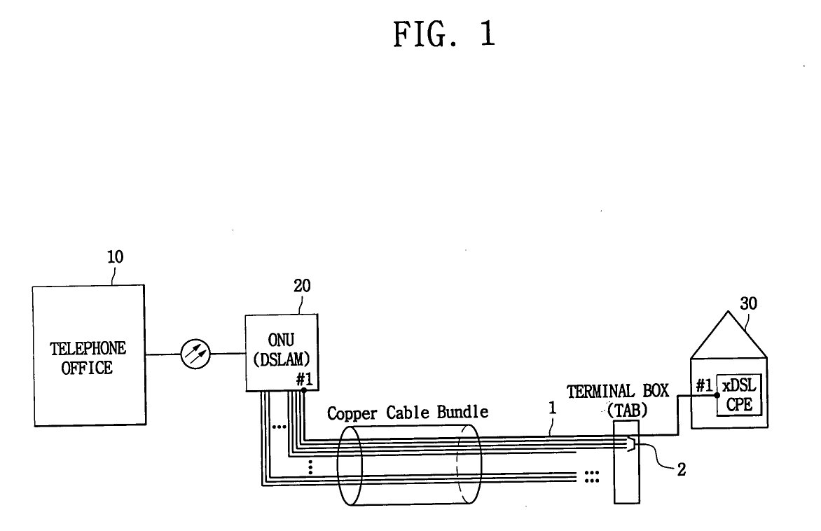

Turning now to the drawings, FIG. 1 is a communication line format diagram to a Customer-Provided Equipment (CPE) from a general telephone office.

Referring to FIG. 1, as for a communication method like xDSL, the xDSL is transmitted to an adjacent home DSLAM 20 from a telephone office 10 by an optical cable, and is connected to a CPE 30 from the DSLAM 20 with the use of telephone lines (Twisted Pair).

At this time, most telephone lines are in a bundle, bound by a plurality of telephone lines, and is connected to a home by being divided in a home entry port through a distributor or a terminal box (TAB).

Generally, the telephone lines distributed from a bundle are supplied with approximately 4 to 5 reserved telephone lines 2 per home. However, among the telephone lines, one telephone line 1 having the best features is used. That is, there are 3 to 4 reserved telephone lines 2 supplied as reserved lines every home, even though they are not currently used at home.

Thus, the XDSL is divided into the DSLAM 20 and the CPE 30, a home terminal equipment, and is connected in 1:1 way, what is called peer-to-peer system, with the use of one telephone line.

Meanwhile, according to Shannon-Heartley Capacity theory, the telephone lines (Twisted Pair) are characteristic of reducing a maximum transfer rate as it is a longer way. So, if distance between the DSLAM and the CPE is far away from a regular range, efficiency and a signaling speed of the xDSL get lower and lower. As a result, an Asymmetric Digital Subscriber Line (ADSL) system or a Very high-date rate Digital Subscriber Line (VDSL) system cannot overcome distance limits in spite of high technologies.

As stated above, an earlier xDSL communication system performs communication by using telephone lines, but has distance limits in terms of characteristics of the telephone lines. In addition, since the telephone lines are in a bundle, the telephone lines are transmitted to each home from the ONU (DSLAM) 20 by various xDSL communication systems. Thus, it gets a much shorter distance due to overlapping or cross talk of usable frequency regions of the telephone lines having different communication systems.

Reference will now be made in detail to exemplary embodiments of the present invention, which are illustrated in the accompanying drawings.

Hereinafter, the present invention will be more fully described in reference to the accompanying drawings.

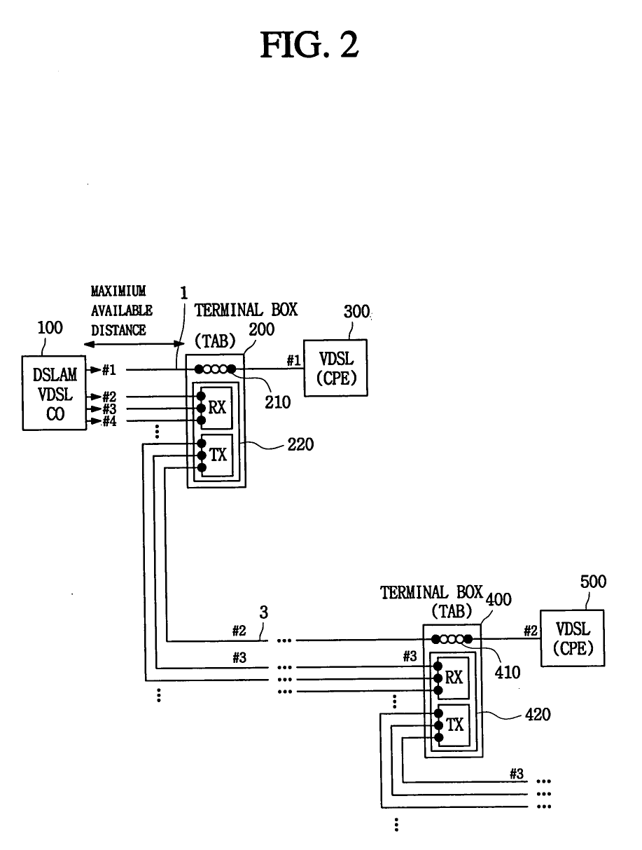

FIG. 2 is a diagram illustrating a concept of extending an available distance of xDSL through modules for distance extension of xDSL using a reserved telephone line in accordance with one embodiment of the present invention

Referring to FIG. 2, a distance extension system in accordance with the present invention, including: a DSLAM 100; a first terminal box 200 separated from the DSLAM 100 at a maximum available distance, and connected to a telephone line; a first CPE 300 connected through a CPE distribution terminal 210 of the first terminal box 200; a second terminal box 400 connected to a distance extension module 220 of the first terminal box 200 by being extended from the distance extension module 220 at a maximum available distance through a reserved telephone line; and a second CPE 500 connected to the second terminal box 400.

The first terminal box 200 can be largely divided into a CPE wiring terminal 210 for performing the same role as a prior system and the module for distance extension 220.

The CPE wiring terminal 210 is connected to the CPE 300 and a main line 1 of telephone line bundles incoming from the DSLAM 100, and connects telephone lines connected by a bundle cable with a home telephone network.

The module for distance extension 220 receives xDSL transmission data from the DSLAM 100 by being connected to each of reserved telephone lines among the telephone line bundles incoming from the DSLAM 100, separates the transmission data received, and transmits the transmission data to the second terminal box 400.

In other words, the module for distance extension 220 uses many reserved telephone lines 2 of the telephone line bundles, receives the xDSL transmission data through the reserved telephone lines 2, and retransmits the xDSL transmission data to the terminal box 400 of a next port.

On this occasion, the first terminal box 200 can be far from the second terminal box 400 at a maximum available distance. In the case of the second terminal box 400, one (3) of the reserved telephone lines is connected to the second CPE 500 through a CPE wiring terminal 410, and the rest of the reserved telephone lines are connected to a module for distance extension 420 in order to be connected with a terminal box (not shown) of a next port. Of course, the module for distance extension 420 of the second terminal box 400 can be separated from the next port (now shown) at a maximum available distance.

Thus, if only the reserved telephone lines are installed in each terminal box, it is possible to continuously extend distance as the maximum available distance.

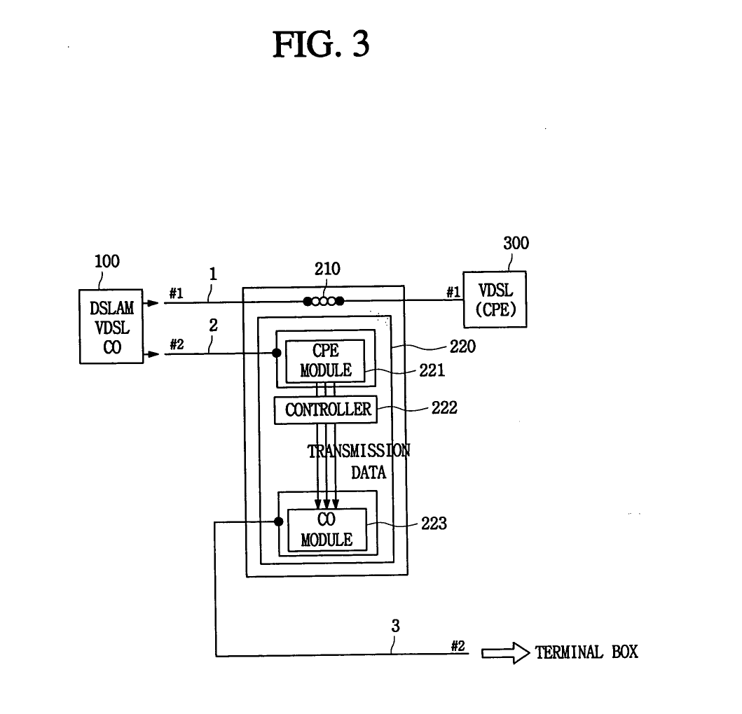

FIG. 3 is a block diagram showing a configuration of a module for distance extension installed in one terminal box of FIG. 2.

Referring to FIG. 3, the module for distance extension installed in a home distributor or the terminal box, including: a CPE wiring terminal 210 connected to a CPE 300 by being connected to a main line of telephone line bundles incoming from a DSLAM 100; a CPE module 221 receiving xDSL transmission data from the DSLAM 100 by being connected to each of reserved telephone lines 2 among the telephone line bundles incoming from the DSLAM 100, and separating the transmission data received, or transmitting optional xDSL transmission data to the DSLAM 100; a CO (Central Office) module 223 transmitting the transmission data separated through the CPE module 221 to other home distributor or a terminal box 400 in order to extend a distance of xDSL, or transmitting transmission data received from the other distributor of the terminal box 400 to the CPE module 221; and a controller 222 relaying the transmission data between the CPE module 221 and the CO module 223.

In this case, a distributor or a terminal box of a CPE port is used as a concept of an xDSL. repeater or an extender re-amplifying transmission data and transmitting the re-amplified transmission data like a repeater or a base station. The CO/CPE modules 221, 223 have the same structure as a previous xDSL equipment or modem.

That is, like shown in FIG. 2, the CPE module 221 like a previous modem, which is an Rx port for receiving the transmission data from the DSLAM, separates the transmission data, and transmits the data by inputting the data to the CO module 223, which is a Tx port, in order to retransmit the separated data.

The controller 222 controls to interwork the RX port with the TX port and to organically operate the two ports. This configuration is applied to both upward and downward data.

The distance extension module configured like above will be more fully described as follows.

First, as for downward transmission data, the CPE module 221 receiving the data transmitted from the DSLAM 100 separates the data and transmits the separated data in order to retransmit the data to the CO module 223 through the controller 222. The CO module 223 receiving the data retransmits the data to a next CPE port. As for upward transmission data similar to the downward transmission data, the CO module 223 receiving the data from the CPE module 300 retransmits the received data to the CPE module 221 through the controller 222.

Each chipset of the CO module 221 and the CPE module 223 is connected to each other according to physical line states and characteristics between the chipsets when attempting an initial link, and performs communication. Like an OAM (Office of Acquisitions Management) system, the chipsets are designed to communicate with each other by periodically diagnosing whether lines are abnormal every certain time.

At this moment, the controller 222 enables the CO module 223 and the CPE module 221 to transceive a status signal without any problems. Namely, the controller 222 solves all the problems caused when the CO module 223 is connected to the CPE module 221 in serial.

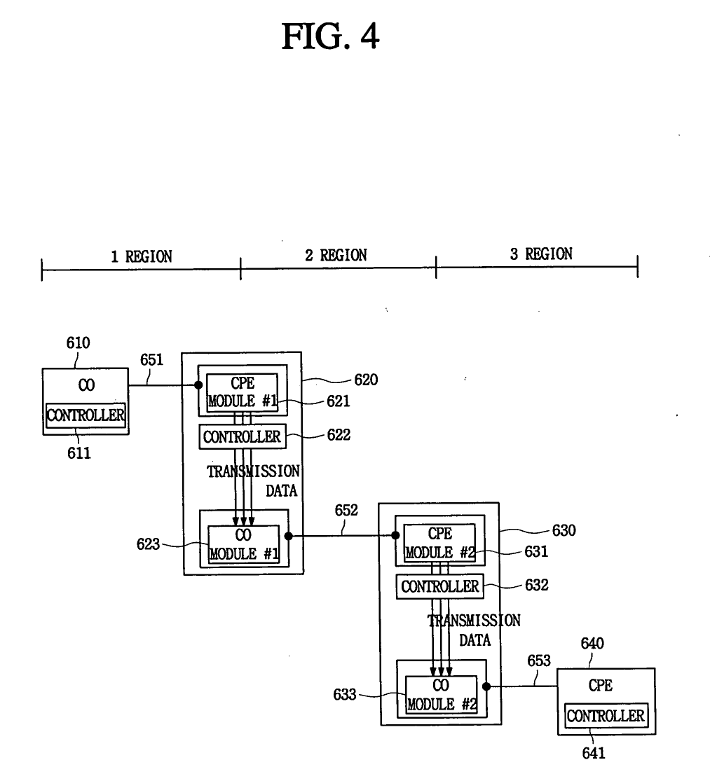

FIG. 4 is a diagram illustrating a concept of extending an available distance of xDSL through an module for distance extension of xDSL using a reserved telephone line in accordance with another embodiment of the present invention, showing an embodiment of adding two distance extension modules so as to give an xDSL service to a home located in 3 times as long as a maximum distance.

Referring to FIG. 4, a DSLAM CO 610 is connected to a CPE 640 through a first module for distance extension 620 and a second module for distance extension 630. Like shown in the diagram, suppose a distance between the DSLAM CO 610 and the first module for distance extension 620 is a first region, a distance between the first module for distance extension 620 and the second module for distance extension 630 is a second region, and a distance between the second module for distance extension 630 and the CPE 640 is a third region.

A CPE module#1 621 of the first module for distance extension 620 located at a maximum distance of xDSL from the DSLAM CO (Central Office) 610, is connected to a reserved telephone line 651 to extend in the first region, and is reconnected to a CO module#1 623 through a controller 622 of the first module for distance extension 620. Then, the CPE module#1 621 is connected to a CPE module#2 631 of the second module for distance extension 630 through a reserved telephone line 652 to extend in the second region.

Then, CO module#2 633 of the second module for distance extension 630 is linked with the CPE 640 through a third-end reserved telephone line 653 to extend in the third region.

With the above configuration, the CPE can communicate to distance of 3 times longer than distance of a current technological xDSL.

An operation of a distance extension system configured like above will be described in detail as follows. For convenience' sake, the operation is described, depending on an initial link setting, data communication, and error generation of a specific end.

First, when setting the initial link, a main chipset of an xDSL module (not shown) in the CO 610 is physically connected to a main chipset of an xDSL module (not shown) in the CPE 640, according to xDSL characteristics.

That is, main chips of the modules 610, 640 distinguish characteristics of physical lines according to a predefined protocol, and set the initial link by determining parameters with which optimal communication can be performed.

In the present invention based on the above process, the CO 610 is connected to the CPE 640 in serial during the initial link. So to speak, while setting the initial link, the CO 610 is linked with the CPE module#1 621 of the first module for distance extension 620. Simultaneously, the CO module#1 623 of the first module for distance extension 620 is linked with the CPE module#2 631 of the second module for distance extension 630, and the CO module#2 633 of the second module. for distance extension 630 is linked with the CPE 640, respectively.

Here, a controller 611 of the first DSLAM CO 610 collects and arranges result values for all link parameters, and tables the result values for storage.

A controller 622 of the first module for distance extension 620 and a controller 632 of the second module for distance extension 630 can use controllers existing in the preceding CO 610 or the CPE 640, and simultaneously control the CO module and the CPE of each module for extension 620, 630 in order to lower a module cost.

In the case of the controller 622 of the first module for distance extension 620, the controller 622 links the CO 610 with the CPE module#1 621 while setting the initial link, and links the CO module#1 623 with the CPE module#2 631 of the second module for distance extension 630. At this point, if the CO 610 is linked with the CPE module#1 621 while storing link parameters between the CO module#1 623 and the CPE module#2 631 through a second-end reserved telephone line 652, the corresponding parameters are transmitted to the controller 611 of the CO 610. Then, the controller 611 of the CO 610 collects and uses all link result data.

In the same way, the second module for distance extension 630 performs linking and transmits corresponding result data. In other words, if the CO module#1 623 is linked with the CPE module#2 631 of the second module for distance extension 630, the controller 632 of the second module for distance extension 630 transmits the corresponding result data to the controller 622 of the first module for distance extension 620 after setting the link like the first module for distance extension 620. Then, the controller 622 of the first module for distance extension 620 retransmits the result data to the controller 611 of the DSLAM CO 610. A controller 641 of the CPE 640 basically performs the same role as a controller of a previous CPE modem, and communicates with the controller 632 of the second module for distance extension 630.

One of the significant features is a link order between the ends. Each ordered module is linked in parallel, and each controller keeps the corresponding link result data until a low ordered link is shown, so that the controller 611 of the first CO 610 can collect all the data.

Namely, though it is longer through each module for distance extension, basically, the same result as 1:1 connection between the CO 610 and the CPE 640 should be obtained. The controller 611 of the CO 610 performs linking with each different module according to characteristics of reserved lines of each module. And the controller 611 recognizes link characteristics of the each module by collecting each link result parameter data, and takes proper measures when links are unstable or disconnected due to future error generation.

As for an operation during data communication, in a structure of an xDSL modem where the previous CO 610 is connected to the CPE 640 one to one, data transmitted from the CO 610 is received through the CPE 640, and is used with a LAN (local area network) card of a computer.

The present invention repeats a process of re-transmitting data received through the CPE module#1 (621) and 2 (631) from the first CO 610, thereby overcoming maximum distance limits of the xDSL by using the first and second modules for distance extension 620, 630 having xDSL repeater effects.

After linking of each end described in the above invention, data is transmitted in an earlier 1:1 structure. This process will be described as follows.

First, the CO 610 transmits the corresponding data to the CPE module#1 621. The data is transmitted to the CO module#1 623 in order to retransmit the data to a next end by the controller 622. The CO module#1 623 transmits the received data to the CPE module#2 631 like communication of the 1:1 structure. The CPE module#2 631 retransmits the received data to the CO module#2 633 through the controller 632, and repeats the above process to transmit the corresponding data to the final CPE 640.

When uploading the data to the CO 610 from the CPE 640, the same repetition process is performed by inversely carrying out the above method.

Next, as for an operation when an error is generated in a specific end, in the earlier 1:1 structure of the previous CO 610 and the CPE 640 only, line characteristics always change due to interference or noise around telephone lines. Accordingly, it is hard to continue communication in terms of the line characteristics. Alternatively, if the line characteristics are inferior to reference values for transmitting the data, the prior connected links should be disconnected to attempt new links in order to obtain link parameters in accordance with the changed line characteristics, and the new links should be connected for optimal communication by the obtained link parameters. Abnormality of the telephone lines and the changed characteristics should be understood by periodically performing OAM (Office of Acquisitions Management) checking after setting the new links.

Like the present invention repeating the earlier 1:1 structure, line characteristics of each end may be different from each other, and links of partial ends can have problems due to peripheral line characteristics of each end. In case a problem occurs while connecting the CO 610 with the CPE 640 due to changes of partial or overall line characteristics like above, it will be described in reference to a simple example as follows.

First, like communication of the earlier 1:1 structure, when performing the OAM checking of each end, the OAM checking is individually performed on each end through communication of the corresponding controllers 611,622,632,641. Moreover, corresponding result data is transmitted to the CO 610, so that the controller 611 of the CO 610 can manage the data by finally collecting the data.

Supposing the CO module#1 623 and the CPE module#2 631 are unlinked by peripheral interference of a second-end reserved line 652, while individually performing the OAM checking on each end, the transmitted data is not transmitted to the CPE 640.

In this case, the adjacent controller 622 capable of communicating with the CO 610 informs the CO 610 of an abnormal link between the CO module#1 623 and the CPE module#2 631 in consideration of user QoS (Quality of Service), and stops transmitting the data until the second-end link is recovered.

The controller 632 of the second distance extension module 630 controls to link by understanding the abnormal link of the second end, informs the controller 641 of the CPE 640 of the abnormal link of the middle end through 3-end communication, so that the controller 641 takes proper measures, and stands by until data communication is re-performed by connecting all the links.

When informed of the abnormal link of a middle end, the controller 641 of the CPE 640 informs a user or other communication apparatus of the abnormal link, and stands by as maintaining the link of the 3 end (third-end) until receiving notices of link connection and start of data transmission from the CO 610.

According to the present invention, it is possible to overcome distance limits of an earlier xDSL by using CO and CPE modules developed in advance and using unused reserved lines.

Therefore, it can reduce development periods and costs with an easy implementation, since the previous CO and CPE modules are used. In addition, it extends distance by retransmitting the data with the use of the dual CO-CPE modules, thereby having robust characteristics for cross talk or external factors influencing other xDSL performance.

Moreover, more efficient xDSL communication can be performed, since it is unnecessary. to increase a spectral power gain. Also, it is possible to extend distance of xDSL by using reserved lines installed but unused, thereby obtaining a lot of effects in terms of efficiency increase and line utility when constructing the telephone lines.

While the invention has been particularly shown and described with reference to the preferred embodiments thereof, it will be understood by those skilled in the art that the foregoing and other changes in form and details may be made therein without departing from the spirit and scope of the invention.

What is claimed is:

1. A system for extending a distance of x Digital Subscriber Line using a reserved telephone line, comprising:
a Customer-Provided Equipment for supplying an x Digital Subscriber Line transmission service to a subscriber terminal;
a Digital Subscriber Line Access Multiplexer setting an initial link with the Customer-Provided Equipment for an x Digital Subscriber Line transmission service, and transceiving data with the Customer-Provided Equipment through the set link; and
a distance extension module being installed with at least more than one module between the. Digital Subscriber Line Access Multiplexer and the Customer-Provided Equipment, in order to receive x Digital Subscriber Line transmission data from the Digital Subscriber Line Access Multiplexer in connection with an optional reserved telephone line selected from telephone line bundles incoming from the Digital Subscriber Line Access Multiplexer, and after separating the received transmission data, to transmit the separated transmission data to a module of a back end or the Customer-Provided Equipment, or to transmit transmission data received from the module of the back end or the Customer-Provided Equipment.

2. The system of claim 1, wherein each distance extension module, comprising: a Customer-Provided Equipment module receiving x Digital Subscriber Line transmission data from the Digital Subscriber Line Access Multiplexer by being connected to each of reserved telephone lines among telephone line bundles incoming from the Digital Subscriber Line Access Multiplexer or a distance extension module of a front end, and separating the received transmission data or transmitting optional x Digital Subscriber Line transmission data to the Digital Subscriber Line Access Multiplexer;
a Central Office module transmitting the transmission data separated through the Customer-Provided Equipment module to a distance extension module of a back end or the Customer-Provided Equipment in order to extend the x Digital Subscriber Line distance, or transmitting transmission data received from the distance extension module of the back end or the Customer-Provided Equipment to the Customer-Provided Equipment; and
a controller setting an initial link between the Customer-Provided Equipment module and the Digital Subscriber Line Access Multiplexer or the Central Office module of the distance extension module of the front end, setting an initial link between the Central Office module and the Customer-Provided Equipment module of the distance extension module of the back end or the Customer-Provided Equipment, transmitting set link information to the Digital Subscriber Line Access Multiplexer, and relaying the transmission data between the Customer-Provided Equipment module and the Central Office module.

3. The system of claim 1, wherein the Digital Subscriber Line Access Multiplexer includes a controller for setting the initial link with the neighboring distance extension modules, receiving the link information set between the distance extension module and the Customer-Provided Equipment, and setting a link to the Customer-Provided Equipment.

4. The system of claim 1, wherein the distance extension module uses reserved telephone lines installed in a home distributor or a terminal box.

5. The system of claim 4, wherein the home distributor or the terminal box uses reserved telephone lines including a Customer-Provided Equipment distribution module for connecting with a home telephone network by being connected to a main line of telephone line bundles from the Digital Subscriber Line Access Multiplexer or the distance extension module of the front end.

6. A method for extending a distance of x Digital Subscriber Line using a reserved telephone line, comprising:
supplying an x Digital Subscriber Line transmission service to a subscriber terminal by a Customer-Provided Equipment;
setting an initial link with the Customer-Provided Equipment for an x Digital Subscriber Line transmission service, and transceiving data with the Customer-Provided Equipment through the set link by a Digital Subscriber Line Access Multiplexer; and
installing a distance extension module with at least more than one module between the Digital Subscriber Line Access Multiplexer and the Customer-Provided Equipment, in order to receive x Digital Subscriber Line transmission data from the Digital Subscriber Line Access Multiplexer in connection with an optional reserved telephone line selected from telephone line bundles incoming from the Digital Subscriber Line Access Multiplexer, and after separating the received transmission data, to transmit the separated transmission data to a module of a back end or the Customer-Provided Equipment, or to transmit transmission data received from the module of the back end or the Customer-Provided Equipment.

7. The method of claim 6, with each distance extension module, comprising:
receiving, by a Customer-Provided Equipment module, x Digital Subscriber Line transmission data from the Digital Subscriber Line Access Multiplexer by being connected to each of reserved telephone lines among telephone line bundles incoming from the Digital Subscriber Line Access Multiplexer or a distance extension module of a front end, and separating the received transmission data or transmitting optional x Digital Subscriber Line transmission data to the Digital Subscriber Line Access Multiplexer;
transmitting, by a Central Office module, the transmission data separated through the Customer-Provided Equipment module to a distance extension module of a back end or the Customer-Provided Equipment in order to extend the x Digital Subscriber Line distance, or transmitting transmission data received from the distance extension module of the back end or the Customer-Provided Equipment to the Customer-Provided Equipment; and
setting, by a controller, an initial link between the Customer-Provided Equipment module and the Digital Subscriber Line Access Multiplexer or the Central Office module of the distance extension module of the front end, setting an initial link between the Central Office module and the Customer-Provided Equipment module of the distance extension module of the back end or the Customer-Provided Equipment, transmitting set link information to the Digital Subscriber Line Access Multiplexer, and relaying the transmission data between the Customer-Provided Equipment module and the Central Office module.

8. The method of claim 7, wherein the Digital Subscriber Line Access Multiplexer comprises setting, by a controller, the initial link with the neighboring distance extension modules, receiving the link information set between the distance extension module and the Customer-Provided Equipment, and setting a link to the Customer-Provided Equipment.

9. The method of claim 7, wherein the distance extension module uses reserved telephone lines installed in a home distributor or a terminal box.

10. The method of claim 9, wherein the home distributor or the terminal box uses reserved telephone lines including a Customer-Provided Equipment distribution module for connecting with a home telephone network by being connected to a main line of telephone line bundles from the Digital Subscriber Line Access Multiplexer or the distance extension module of the front end.

11. A system for extending a distance of x Digital Subscriber Line using a reserved telephone line, comprising:
a first unit supplying an x Digital Subscriber Line transmission service to a subscriber terminal;
a second unit setting an initial link with the first unit for an x Digital Subscriber Line transmission service, and transceiving data with the first unit through the set link; and
a third unit being installed with at least more than one module between the Digital Subscriber Line Access Multiplexer and the first unit, in order to receive x Digital Subscriber Line transmission data from the second unit in connection with an optional reserved telephone line selected from telephone line bundles incoming from the second unit, and after separating the received transmission data, to transmit the separated transmission data to a module of a back end or the first unit, or to transmit transmission data received from the module of the back end or the first unit.

12. The system of claim 1 1, wherein each third unit, comprising:
a fourth unit receiving x Digital Subscriber Line transmission data from the Digital Subscriber Line Access Multiplexer by being connected to each of reserved telephone lines among telephone line bundles incoming from the second unit or the third unit of a front end, and separating the received transmission data or transmitting optional x Digital Subscriber Line transmission data to the second unit;
a fifth unit transmitting the transmission data separated through the fourth unit to a distance extension module of a back end or the first unit in order to extend the x Digital Subscriber Line distance, or transmitting transmission data received from the distance extension module of the back end or the first unit to the first unit; and
a sixth unit setting an initial link between the fourth unit and the second unit or the fifth unit of the distance extension module of the front end, setting an initial link between the fifth unit and the fourth unit of the third unit of the back end or the first unit, transmitting set link information to the second unit, and relaying the transmission data between the fourth unit and the fifth unit.

13. The system of claim 12, wherein the second unit includes a controller for setting the initial link with the neighboring third units, receiving the link information set between the third unit and the first unit, and setting a link to the first unit.

14. The system of claim 13, wherein the third unit uses reserved telephone lines installed in a home distributor or a terminal box.

15. The system of claim 14, wherein the home distributor or the terminal box uses reserved telephone lines including a Customer-Provided Equipment distribution module for connecting with a home telephone network by being connected to a main line of telephone line bundles from the second unit or the third unit of the front end.
